(19) United States
(12) Patent Application Publication
(10) Pub. No.: US 2008/0285761 A1
(43) Pub. Date: Nov. 20, 2008

(54) FILTER CIRCUIT

(75) Inventors: Tatsuya MANO, Kyoto (JP); Koji SAITO, Kyoto (JP); Hisashi FURUMOTO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/018,558

(22) Filed: Jan. 23, 2008

(30) Foreign Application Priority Data
Jan. 23, 2007 (JP) JP2007-012493
Nov. 29, 2007 (JP) JP2007-309110

(51) Int. Cl. H04B 1/04; G06F 17/10; H04H 20/48

(52) U.S. Cl. 381/3; 708/300

(57) ABSTRACT

A pre-emphasis filter emphasizes a high-frequency component of an input audio signal. A limiter circuit detects that the output signal from the pre-emphasis filter reaches a predetermined upper limit level. A filter adjusting circuit changes the frequency characteristic of the pre-emphasis filter when a limit operation is generated in the limiter circuit.

### BACKGROUND OF THE INVENTION

1. Field of the Invention

The present invention relates to a filter circuit provided at a prestage of a frequency modulator.

2. Description of the Related Arts

An FM transmitter that converts an audio signal to a stereo composite signal, frequency-modulates the stereo composite signal using a frequency modulator and outputs the obtained signal has been known. Such FM transmitter is able to transmit the audio signal without using wirings such as RCA cable, and thus is used in transmitting signals between the CD changer of a car audio and the main head unit. Furthermore, hard disc audio equipment, memory audio equipment, portable telephone terminals having music reproducing function are significantly becoming widely used in recent years, and FM transmitter is used to reproduce musical data stored in such compact electronic equipment from a speaker of a stationary audio component stereo and the like. Japanese Patent Application (Laid-Open) Nos. H09-069729, H10-013370 and No. H09-312588 disclose related frequency modulators and FM transmitters.

In a frequency modulating (FM) system, an SN ratio is proportional to the modulation index, while the modulation index is inversely proportional to a modulation frequency. Therefore, as the modulation frequency increases, the modulation index decreases, so that the SN ratio is deteriorated. In view of this, a filter circuit including a pre-emphasis filter for emphasizing a high frequency component of the audio signal or a low pass filter for removing the high frequency component is provided at a prestage of a frequency modulator in an FM transmitter (see Japanese Patent Application (Laid-Open) No. H09-312588).

When a signal having a large amplitude is input to the frequency modulator, overmodulation is caused, so that the band of the frequency of the modulated signal deviates from the specification. In order to prevent this situation, it is general that a limiter circuit is provided between a pre-emphasis filter and a frequency modulator. The limiter circuit monitors the amplitude of the audio signal, and when the amplitude reaches a predetermined upper limit level, the limiter circuit controls the level of the audio signal.

Providing the limiter circuit can prevent the occurrence of the overmodulation on the frequency modulator. However, when the limiter circuit is operated, the waveform of the audio signal is distorted in a rectangular form, thereby causing a problem that the sound quality is remarkably deteriorated.

### SUMMARY OF THE INVENTION

The present invention is accomplished in view of the foregoing problem, and its general purpose is to provide a filter circuit that can prevent the overmodulation and reduce the distortion.

A filter circuit according to one embodiment of the present invention is a filter circuit arranged at a prestage of a frequency modulator, including a pre-emphasis filter that emphasizes the high-frequency component of an input audio signal, a limiter circuit, which detects that an output signal from the pre-emphasis filter reaches a predetermined upper limit level (sometimes referred to as a limit value), and a filter adjusting circuit that changes the frequency characteristic of the pre-emphasis filter when the limit operation is generated in the limiter circuit.

The degree of emphasizing the high-frequency component is changed by changing the frequency characteristic of the pre-emphasis filter, whereby it is prevented that the output signal from the pre-emphasis filter reaches the limit value of the limiter circuit. Therefore, the overmodulation and waveform distortion can be prevented.

The frequency characteristic of the pre-emphasis filter that is changed by the filter adjusting circuit may be a time constant, and this time constant may be reduced when the limit operation is generated.

By reducing the time constant (slope) of the high pass filter, the gain of the high-frequency component is reduced, whereby the peak value of the time waveform of the audio signal can be reduced, and hence, can be prevented from reaching the limit value.

The pre-emphasis filter may be a digital filter, and the filter adjusting circuit may change the coefficient of the digital filter so as to change the frequency characteristic.

The digital filter may include first, second and third multipliers, first, second and third adders, and a delay circuit. The first and the second multiplier may respectively multiply the input signal by predetermined first and second coefficients, the third multiplier may multiply the output signal from the second adder by a predetermined third coefficient, the first adder may add the output signals from the first multiplier and the third multiplier, the delay circuit may delay the output signal from the first adder, the second adder may add the output signal from the delay circuit and the output signal from the second multiplier, the third adder may add the output signal and the input signal of the second adder and output the resultant to the outside, and the filter adjusting circuit may change the first and second coefficients.

When the limit operation is generated, the filter adjusting circuit may set the absolute values of the first and second coefficients to be small, and then, increase the same with the lapse of time.

The time constant can preferably be changed by changing the first and second coefficients.

The frequency characteristic of the pre-emphasis filter changed by the filter adjusting circuit may be a cut-off frequency, and the cut-off frequency may be increased when the limit operation is generated.

Since the gain of the high-frequency component is reduced by increasing the cut-off frequency of the high pass filter, the peak value of the time waveform of the audio signal can be reduced, and hence, can be prevented from reaching the limit value.

The digital filter may include first, second and third multipliers, first, second and third adders, and a delay circuit. The first and the second multiplier may respectively multiply the input signal by predetermined first and second coefficients, the third multiplier may multiply the output signal from the second adder by a predetermined third coefficient, the first adder may add the output signals from the first multiplier and the third multiplier, the delay circuit may delay the output signal from the first adder, the second adder may add the output signal from the delay circuit and the output signal from the second multiplier, the third adder may add the output signal and the input signal of the second adder and output the resultant to the outside, and the filter adjusting circuit may change the third coefficient.

The cut-off frequency can preferably be changed by changing the third coefficient.

When the limit operation is generated, the filter adjusting circuit may set the absolute value of the third coefficient to be great, and then, decrease the same with the lapse of time.

The filter circuit may be monolithically integrated on a single semiconductor substrate. The term “monolithically integrated” includes a case in which all the components of a circuit are formed on the semiconductor substrate and a case in which the main components of a circuit are monolithically integrated, wherein some resistors or capacitors may be provided at the outside of the semiconductor substrate for adjusting a circuit constant. These circuits are integrated as a single LSI, whereby the circuit area can be reduced.

Another embodiment of the present invention is an FM transmitter. This FM transmitter includes the filter circuit according to any one of the aforesaid embodiments, a stereo modulation circuit that stereo-modulates the output signal from the filter circuit so as to produce a stereo composite signal, a frequency modulator that frequency-modulates the stereo composite signal from the stereo modulation circuit, and a power amplifier that amplifies the output signal from the frequency modulator. The FM transmitter is monolithically integrated on a single semiconductor substrate.

According to this embodiment, a signal in which overmodulation and waveform distortion are prevented can be transmitted.

Another embodiment of the present invention is electronic equipment. This electronic equipment includes a sound source that outputs an audio signal, the aforesaid FM transmitter that receives the audio signal, stereo-modulates and frequency-modulates the audio signal, and outputs the resultant, and an antenna that transmits the output signal from the FM transmitter to the outside.

According to this embodiment, a signal in which overmodulation and waveform distortion are prevented can be transmitted from an antenna.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing an overall configuration of electronic equipment that utilizes a filter circuit and FM transmitter according to an embodiment of the present invention;

FIG. 2 is a circuit diagram showing an example of a configuration of a pre-emphasis filter;

FIGS. 3A and 3B are views showing frequency characteristics adjusted by first and second systems; and

FIG. 4 is a circuit diagram of the FM transmitter and peripheral circuits.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “a state in which a member A is connected to a member B” includes a case in which the member A and the member B are physically directly connected to each other, and a case in which the member A and the member B is indirectly connected via another member that does not affect the electrical connection.

Similarly, “a state in which a member C is provided between the member A and the member B” includes a case in which the member A and the member C or the member B and the member C are directly connected, and a case in which the member A and the member C or the member B and the member C are indirectly connected via another member that does not affect the electrical connection.

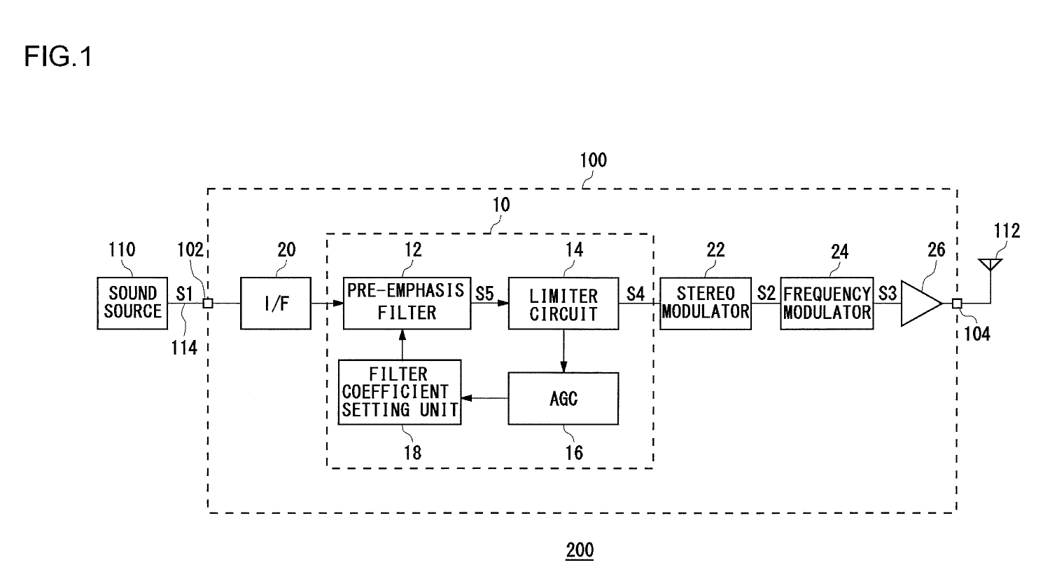

FIG. 1 is a block diagram showing an overall configuration of electronic equipment 200 using a filter circuit 10 and an FM transmitter 100 according to an embodiment of the present invention. This electronic equipment 200 is, for example, a cellular phone terminal, a radio receiver, or a silicon audio player, having audio reproduction function. The reproduced audio signal can be output from an electroacoustic transducing element itself such as a speaker or earphone provided to the electronic equipment 200. In addition, the electronic equipment 200 FM-modulates an audio signal and can transmit the FM-modulated signal to the outside as an electric wave in order to enable an audio reproduction with high quality of sound. A user can receive the transmitted signal by an external audio player and can reproduce the signal with higher quality of sound.

The electronic equipment 200 includes a sound source 110, the FM transmitter 100, and an antenna 112.

The sound source 110 outputs an audio signal S1. For example, the audio signal S1 may be a signal obtained by receiving and decoding a broadcasting wave or may be a signal obtained by reproducing the data stored in a memory. Any methods of generating the audio signal can be employed. The sound source 110 and the FM transmitter 100 are connected with a bus 114 having a predetermined form. For example, the bus 114 is an I2S bus. In this case, the audio signal S1 is transmitted as serial data between the sound source 110 and the FM transmitter 100. The FM transmitter 100 receives an audio signal S1 from the sound source 110. The FM transmitter 100 includes the filter circuit 10, an interface unit 20, a stereo modulator 22, the frequency modulator 24, and a power amplifier 26, and these components are monolithically integrated on a single semiconductor substrate as a functional IC (Integrated Circuit) FIG. 1 only shows a main circuit block, and the other blocks are appropriately omitted.

The interface unit 20 receives the audio signal S1 from the sound source 110 through an input terminal 102. The interface unit 20 receives the audio signal S1, and outputs the signal to the filter circuit 10. The filter circuit 10 is arranged at the prestage of the stereo modulator 22 and the frequency modulator 24 for emphasizing the high-frequency component of the audio signal S1. The output signal of the filter circuit 10 is designated as S4.

The stereo modulator 22 performs a stereo modulation to the audio signal S4 so as to generate a stereo composite signal S2. The frequency modulator 24 frequency-modulates the transmitted signal with the stereo composite signal S2 defined as a modulation signal. The audio signal whose frequency is modulated (hereinafter sometimes referred to as a modulated signal) S3 is input to the power amplifier 26. The power amplifier 26 receives the modulated signal S3 and amplifies the signal. The antenna 112 is connected to the output terminal 104 of the FM transmitter 100 through a matching circuit (not shown). The signal whose frequency is modulated is transmitted from the antenna 112.

The configuration of the filter circuit 10 will be explained below in detail.

The filter circuit 10 includes a pre-emphasis filter 12, a limiter circuit 14, a filter adjusting circuit 16, and a filter coefficient setting unit 18.

The pre-emphasis filter 12 emphasizes the high-frequency component of the input audio signal S1. For example, the pre-emphasis filter 12 is a first-order high pass filter.

The limiter circuit 14 monitors an output signal S5 of the pre-emphasis filter 12, and detects that it reaches the predetermined upper limit level (limit value). A state in which the output signal S5 reaches the limit value is referred to as a limit operation.

When the limit operation is generated in the limiter circuit 14, the filter adjusting circuit 16 changes the frequency characteristic of the pre-emphasis filter 12. Changing the frequency characteristic of the filter means the change of gain (attenuation factor). Accordingly, from this viewpoint, the filter adjusting circuit 16 executes an AGC (automatic gain control) function. Further, when the level of the input signal exceeds the limit value, the limiter circuit 14 may clamp the input signal to be not more than the limit value.

In the present embodiment, the pre-emphasis filter 12 is an IIR (Infinite Impulse Response) type digital filter. The filter adjusting circuit 16 changes the frequency characteristic by changing the coefficient of multipliers in the pre-emphasis filter 12.

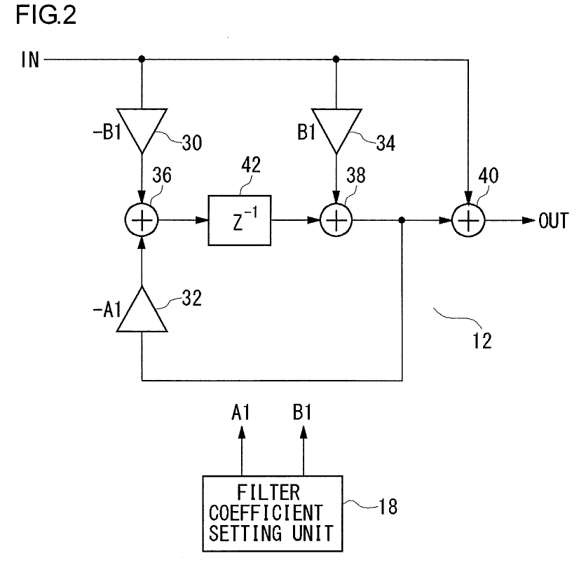

FIG. 2 is a circuit diagram showing the example of the configuration of the pre-emphasis filter 12.

The pre-emphasis filter 12 includes a first multiplier 30, a second multiplier 34, a third multiplier 32, a first adder 36, a second adder 38, a third adder 40, a delay circuit 42, and a filter coefficient setting unit 18.

The first multiplier 30 and the second multiplier 34 multiply the input signal IN (i.e., the audio signal S1) by predetermined first coefficient (−B1) and second coefficient (B1) The absolute values of the first and second coefficients are the same, but the sign is different from each other. The third multiplier 32 multiplies the output signal from the second adder 38 by a predetermined third coefficient (−A1).

The first adder 36 adds the output signals of the first multiplier 30 and the third multiplier 32. The delay circuit 42 delays the output signal from the first adder 36. The second adder 38 adds the output signal of the delay circuit 42 and the output signal of the second multiplier 34. The third adder 40 adds the output signal and the input signal IN of the second adder 38, and outputs the resultant to the outside. The filter coefficient setting unit 18 changes at least one of the first to third coefficients on the basis of the instruction from the filter adjusting circuit 16 so as to adjust the frequency characteristic of the pre-emphasis filter 12. It is to be noted that the configuration of the pre-emphasis filter 12 is not limited to that shown in FIG. 2.

In the present embodiment, the adjustment of the frequency characteristic is executed by one of two systems, or by the combination of them. Each system will successively be explained below.

(First System)

In the first system, the frequency characteristic of the pre-emphasis filter 12 changed by the filter adjusting circuit 16 is a time constant τ. The time constant τ is prescribed for every country or every region. In Japan, the time constant τ is 50 μs, and in the United States, the time constant τ is 75 μs.

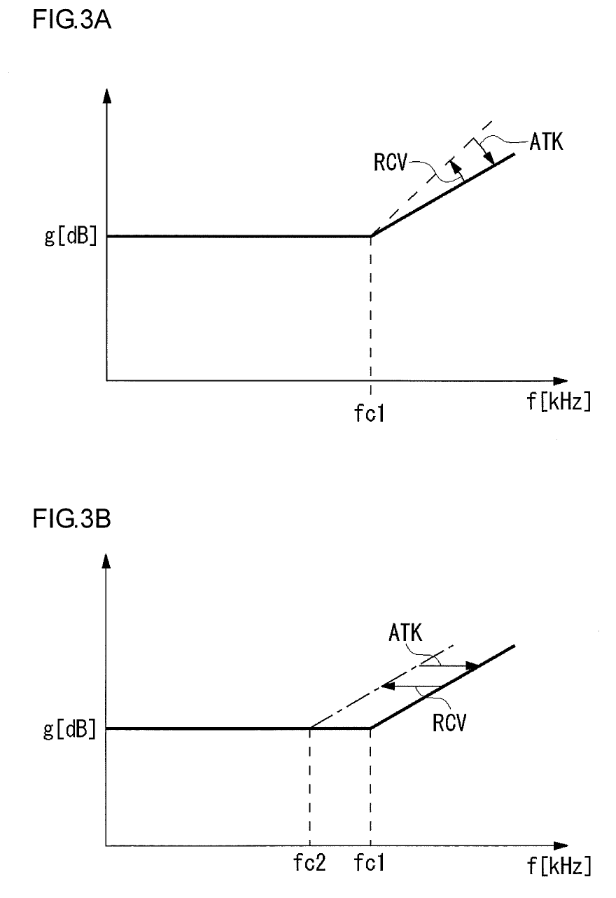

In the first system, when the limit operation is generated in the limiter circuit 14, the time constant τ is reduced. FIG. 3A is a graph showing the frequency characteristic adjusted by the first system. In FIG. 3A, the frequency characteristic in the normal state, that is, in the state in which the limit operation is not generated is indicated by a broken line, while the frequency characteristic when the limit operation is generated is indicated by a solid line.

In the first-order high pass filter, the time constant τ corresponds to the slope. The filter adjusting circuit 16 executes an attack operation ATK for reducing the time constant, when the limit operation is generated. As a result, the gain of the high-frequency component exceeding the cut-off frequency fc1 reduces. Therefore, the peak value of the filter circuit 10 is reduced to be not more than the limit level, whereby the waveform distortion can be prevented.

When the limit operation is generated, the filter coefficient setting unit 18 sets the absolute values of the first coefficient (−B1) and the second coefficient (B1) to be small in order to reduce the time constant τ.

When the attack operation ATK is generated, the value of the time constant τ may be reduced to 0 μs. In this case, the pre-emphasis filter 12 temporarily loses the function as the high pass filter immediately after the attack operation. As a result, the high-frequency component can sufficiently be suppressed.

The filter adjusting circuit 16 executes a recovery operation RCV for gently recovering the time constant to the original value after the attack operation ATK. In this case, the filter coefficient setting unit 18 increases the absolute values of the first coefficient (−B1) and the second coefficient (B1) to the original values with the lapse of time.

(Second System)

In the second system, the filter adjusting circuit 16 changes the cut-off frequency fc of the pre-emphasis filter 12. Specifically, the filter adjusting circuit 16 increases the cut-off frequency fc when the limit operation is generated at the limiter circuit 14.

FIG. 3B is a graph showing the frequency characteristic adjusted by the second system. In FIG. 3B, the frequency characteristic in the normal state, that is, in the state in which the limit operation is not generated is indicated by a broken line, while the frequency characteristic when the limit operation is generated is indicated by a solid line.

The filter adjusting circuit 16 executes the attack operation ATK for increasing the cut-off frequency from fc2 to fc1, when the limit operation is generated. As a result, the gain of the high-frequency component exceeding the cut-off frequency fc2 is reduced. Therefore, the peak value of the filter circuit 10 reduces to be not more than the limit level, whereby the waveform distortion can be prevented.

When the limit operation is generated, the filter coefficient setting unit 18 sets the absolute value of the third coefficient (A1) to be small in order to reduce the cut-off frequency.

The filter adjusting circuit 16 executes the recovery operation RCV for gently recovering the cut-off frequency to the original value after the attack operation ATK. In this case, the filter coefficient setting unit 18 increases the absolute value of the third coefficient (−A1) to the original value with the lapse of time.

According to the first and second systems, even if the audio signal S1 having instantaneously large amplitude is input, the pre-emphasis characteristic is changed to attenuate the high-frequency component, whereby the peak level of the audio signal can be suppressed. When a process for clamping an audio signal exceeding a peak level is performed as is done in a conventional limiter circuit, the waveform distortion is significantly produced. On the other hand, in the present embodiment, the pre-emphasis of the high-frequency component is suppressed, with the result that the amplitude of the audio signal can be reduced, and hence, the waveform distortion can be reduced. When the time constant of the pre-emphasis is changed at the transmitter side, it is assumed that the original waveform cannot be recovered in a de-emphasis process at a receiver side and therefore the waveform distortion is generated. However, compared to the case in which the peak of the audio signal is clamped, the level of the distortion can be made small.

A more preferable limit process and pre-emphasis process can be realized by combining the first system and the second system.

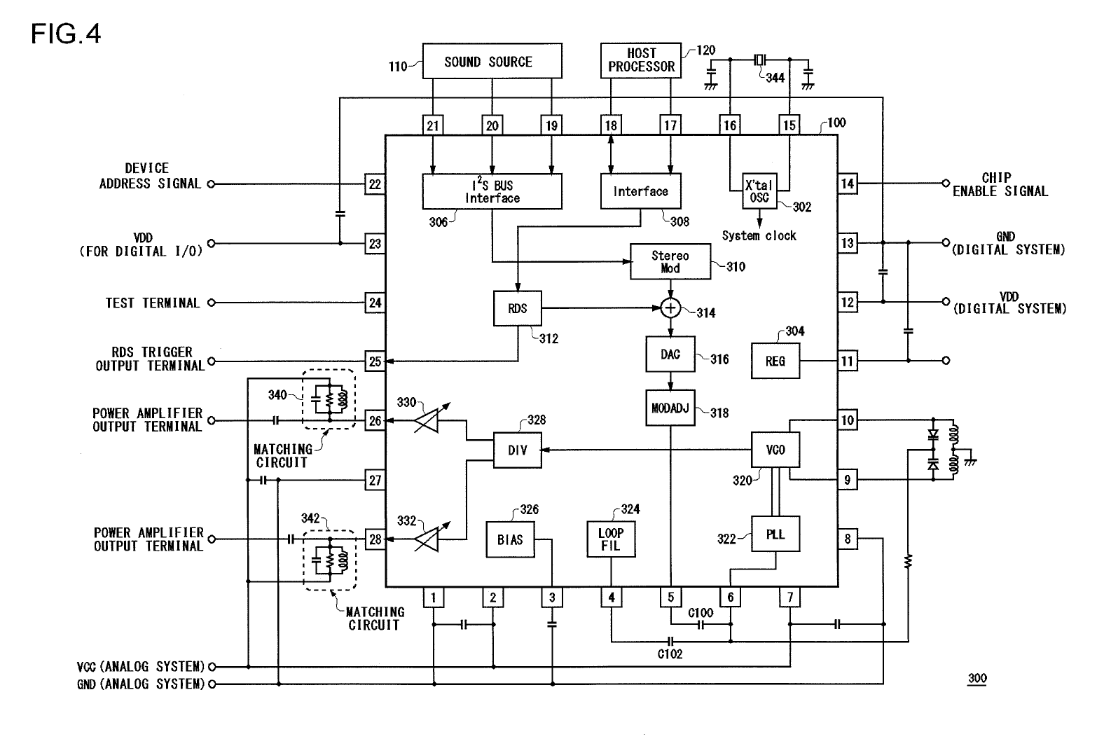

FIG. 4 is a circuit diagram of the FM transmitter 100 and the peripheral circuits. The IC of the FM transmitter 100 includes 1st pin to 28th pin.

A power supply voltage Vcc and a grounding voltage GND to an analog circuit in the FM transmitter 100 are supplied to the 1st pin, 2nd pin, 7th pin, 8th pin, and 27th pin. A power supply voltage Vdd and a grounding voltage GND to the digital circuit are supplied to the 12th pin, 13th pin, and 23rd pin.

A regulator 304 generates a voltage used in an internal logic in the FM transmitter 100. The voltage generated by the regulator 304 is output from the 11th pin. The sound source 110 is connected to the 19th pin to 21st pin via the I2Sbus. The 19th pin is used for data, the 20th pin is used for a clock, and the 21st pin is used for an LR clock. An I2S bus interface unit 306 transmits and receives data to and from the sound source 110.

The host processor 120 is connected to the 17th pin and the 18th pin via an I2C bus. The 17th pin is used for a clock signal, and the 18th pin is used for a data signal.

A quartz vibrator 344 is connected to the 15th pin and the 16th pin. An oscillator 302 provides a system clock.

A chip enable signal is input to the 14th pin. The changeover between a mode in which the FM transmitter 100 normally operates and a power down mode is executed by the chip enable signal. In the power down mode, the internal circuit is shut down, so that the current consumption becomes almost zero, and the internal circuit does not accept an external signal.

A device address selection signal is input to the 22nd pin. The device address selection signal is set for discriminating an LSI, which is controlled by the common I2C bus, and the FM transmitter 100, when such LSI is present except for the FM transmitter 100. The 24th pin is a test terminal.

The 25th pin is an RDS trigger output terminal. An RDS digital modulator 312 notifies, to the circuit block other than the FM transmitter 100 through the 25th pin, the transmission of the RDS signal to the FM transmitter 100 from the outside.

A stereo modulator 310 accepts the audio signal received from the sound source 110, and stereo-modulates the signal so as to generate a stereo composite signal. The RDS digital modulator 312 sequentially reads out the data from the host processor 120 to execute a binary phase shift keying modulation, performs filtering, and outputs the resultant data. An adder 314 adds the RDS/RBDS data output from the RDS digital modulator 312 to the stereo composite signal.

A DAC 316 performs a digital/analog conversion on the output from the adder 314. The amplitude of the DAC 316 is adjusted by a modulation degree adjusting unit 318, and supplied to a PLL 322 through the 5th pin, an external capacitor C100 and the 6th pin. The 6th pin is connected to a loop filter 324 through the capacitor C102 and the 4th pin (PLL time constant switching terminal). The loop filter 324 is formed by the capacitor C102 connected to the 4th pin and resistor (not shown) in the FM transmitter 100, and the time constant is adjusted by changing the capacitance value of the capacitor C102 or changing the resistance value.

A VCO 320 oscillates with a frequency according to the signal from the PLL, and supplies the FM-modulated signal to a divider 328. A variable capacitance diode and an inductor are connected to the VCO 320 through the 9th pin and the 10th pin.

The FM transmitter 100 has two systems of power amplifier. The divider 328 outputs signals to the power amplifiers 330 and 332. The output from the power amplifier 330 is output to the outside from the 26th pin. A matching circuit 304 is connected to the 26th pin. The output from the power amplifier 332 is output to the outside from the 28th pin. A matching circuit 342 is connected to the 28th pin. Two systems of the power amplifier and the matching circuit are provided, whereby the frequency characteristic can be adjusted in accordance with the load (antenna) of the respective systems.

The correspondence relationship between FIGS. 1 and 4 are shown below.

| | |
|---|---|
| Interface unit 20: | Interface 306 |
| Filter circuit: | Not shown |
| Stereo modulator 22: | Stereo modulator 310 |

Frequency modulator 24: DAC 316, modulation degree adjusting unit 318, loop filter 324, PLL 322, VCO 320

Power amplifier 26: Divider 328, Power amplifier 330, 332

The embodiment is for illustrative purpose only, and it is to be understood by a person skilled in the art that various modifications are possible for the combination of these components and processes, and the modifications are within the scope of the present invention.

The embodiment describes a case in which the pre-emphasis filter 12 is composed of a digital filter. However, the present invention is not limited thereto. The pre-emphasis filter 12 may be composed of an analog filter using CR. In this case, the effect same as that obtained by the present embodiment can be obtained by appropriately changing the value of the capacitor or the value of the resistor.

Further, a switched capacitor filter may be used for the pre-emphasis filter 12. In this case, a switching frequency, value of the capacitor or the value of the resistor may be changed.

While the preferred embodiments of the present invention have been described using specific terms, such description is for illustrative purposes only, and it is to be understood that changes and variations may be made without departing from the spirit of scope of the appended claims.

What is claimed is:

1. A filter circuit arranged at a prestage of a frequency modulator, comprising:
a pre-emphasis filter that emphasizes a high-frequency component of an input audio signal;
a limiter circuit, which detects that an output signal from the pre-emphasis filter reaches a predetermined upper limit level; and
a filter adjusting circuit that changes the frequency characteristic of the pre-emphasis filter when the limit operation is generated in the limiter circuit.

2. A filter circuit according to claim 1, wherein
the frequency characteristic of the pre-emphasis filter changed by the filter adjusting circuit is a time constant, and the time constant is reduced when the limit operation is generated.

3. A filter circuit according to claim 1, wherein
the pre-emphasis filter is a digital filter, and
the filter adjusting circuit changes the coefficient of the digital filter so as to change the frequency characteristic.

4. A filter circuit according to claim 3, wherein
the digital filter includes:
first, second and third multipliers;
first, second and third adders; and
a delay circuit,
the first and the second multipliers respectively multiply the input signal by predetermined first and second coefficients,
the third multiplier multiplies the output signal from the second adder by a predetermined third coefficient,
the first adder adds the output signals from the first multiplier and the third multiplier,
the delay circuit delays the output signal from the first adder,
the second adder adds the output signal from the delay circuit and the output signal from the second multiplier,
the third adder adds the output signal and the input signal of the second adder and output the resultant to the outside, and
the filter adjusting circuit changes the first and second coefficients.

5. A filter circuit according to claim 4, wherein
the filter adjusting circuit sets the absolute values of the first and second coefficients to be small, and then, increases the same with the lapse of time, when the limit operation is generated.

6. A filter circuit according to claim 1, wherein the frequency characteristic of the pre-emphasis filter changed by the filter adjusting circuit is a cut-off frequency, and the cut-off frequency is increased when the limit operation is generated.

7. A filter circuit according to claim 3, wherein
the digital filter includes:
first, second and third multipliers;
first, second and third adders; and
a delay circuit,
the first and the second multiplier respectively multiply the input signal by predetermined first and second coefficients,
the third multiplier multiplies the output signal from the second adder by a predetermined third coefficient,
the first adder adds the output signals from the first multiplier and the third multiplier,
the delay circuit delays the output signal from the first adder,
the second adder adds the output signal from the delay circuit and the output signal from the second multiplier,
the third adder adds the output signal and the input signal of the second adder and output the resultant to the outside, and
the filter adjusting circuit changes the third coefficient.

8. A filter circuit according to claim 7, wherein
the filter adjusting circuit sets the absolute value of the third coefficient to be great, and then, decreases the same with the lapse of time, when the limit operation is generated.

9. A filter circuit according to claim 1, which is monolithically integrated on a single semiconductor substrate.

10. An FM transmitter comprising:
the filter circuit according to claim 1;
a stereo modulation circuit that stereo-modulates the output signal from the filter circuit so as to produce a stereo composite signal;
a frequency modulator that frequency-modulates the stereo composite signal from the stereo modulation circuit; and
a power amplifier that amplifies the output signal from the frequency modulator, wherein
the FM transmitter is monolithically integrated on a single semiconductor substrate.

11. Electronic equipment comprising:
a sound source that outputs an audio signal;
the FM transmitter according to claim 10 that receives the audio signal, stereo-modulates and frequency-modulates the audio signal, and outputs the resultant; and
an antenna that transmits the output signal from the FM transmitter to the outside.
